(19) United States
(12) Patent Application Publication
(10) Pub. No.: US 2010/0225590 A1
(43) Pub. Date: Sep. 9, 2010

(54) Portable Wearable Input Apparatus

(75) Inventor: Jude Francis Pereira, Bangalore (IN)

Correspondence Address: Ashok Tankha, 36 Greenleigh Drive, Sewell, NJ, 08080, US

(73) Assignee: MindTree Limited

(21) Appl. No.: 12/717,136

(22) Filed: Mar. 4, 2010

(30) Foreign Application Priority Data
Mar. 4, 2009 (IN) 477/CHE/2009

(51) Int. Cl. G06F 3/02

(52) U.S. Cl. 345/169

(57) ABSTRACT

A portable wearable input apparatus and method are provided for furnishing input to one or more devices. The portable wearable input apparatus comprises a wearable unit, for example, a mitten, a finger band, etc., configured to conform to a wearer's body part, keystroke registering units detachably disposed on the wearable unit, a mounting unit, and removable electrical connectors. The chamber accommodates the wearer's body part, for example, the wearer's hand. A thumb opening is disposed alongside the chamber of the wearable unit for passing the wearer's thumb. The keystroke registering units enable the wearer to register keystrokes on activation. The mounting unit is in electric communication with the keystroke registering units. The mounting unit mechanically supports the keystroke registering units and transmits the registered keystrokes to the devices. The removable electrical connectors are in electric communication with the mounting unit for transmitting the registered keystrokes as input to the devices.

### CROSS REFERENCE TO RELATED APPLICATIONS

This application claims the benefit of provisional patent application number 477/CHE/2009 titled “Portable Wearable Input Apparatus”, filed on Mar. 4, 2009 in the Indian Patent Office.

The specification of the above referenced patent application is incorporated herein by reference in its entirety.

### BACKGROUND

This invention, in general, relates to input technologies. More particularly, this invention relates to a portable wearable input apparatus for furnishing input to one or more devices.

Persons suffering from cerebral palsy are most often unable to use a computer keyboard as they lack precision and control of their hands and fingers to press the keys of the keyboard. The available input devices require persons with disabilities to move their arms, legs, head, etc., to operate a switching device, which in turn help the disabled persons to operate a device such as a computer. Some vendors have developed wider diameter switching devices for persons with disabilities. These switching devices are either placed on a desk, table, a stand, or on mountings. This requires the disabled persons to somehow try and reach out to these switching devices, thereby expecting them to move their limbs. Persons suffering from cerebral palsy or spastic quadruparesis, find it very difficult to operate these switching devices due to the effort involved in moving their limbs to operate these switching devices.

In some cases, switching devices are positioned on a glove for registering keystrokes by contact with a person's fingers. However, the glove with finger sheaths provides a minimal surface area, for example, the finger area for placement of switching devices. Therefore, there is a need for a wearable input apparatus that provides a wider area for positioning multiple switching devices for registering keystrokes. Moreover, there is a need for a wearable input apparatus that enables flexible movement of a wearer's thumb over the fingers for contacting the switching devices and registering the keystrokes.

Furthermore, persons suffering from motor disabilities are typically unable to play games on computers or gaming consoles due to an inability to use conventional game controllers. Therefore, there is a need for creating a game controller by selectively positioning easily accessible game components on a wearable input apparatus.

Hence, there is a need for a portable wearable input apparatus that makes it easier for disabled persons to operate a device, for example, a computer and its peripherals such as a keyboard, mouse, joystick, a game controller, etc., with minimal movement of their limbs. Furthermore, there is a need for a portable wearable input apparatus that provides an increased surface area for mounting keystroke registering devices and other devices, and that enables flexible movement of a wearer's thumb for operating the devices.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The portable wearable input apparatus and method disclosed herein addresses the above stated need for furnishing input to one or more devices. The portable wearable input apparatus disclosed herein makes it easier for disabled persons to operate a device, for example, a computer and its peripherals such as a keyboard, mouse, joystick, a game controller, etc. with minimal movement of their limbs. The portable wearable input apparatus disclosed herein also provides an increased surface area for mounting devices, and enables flexible movement of a wearer's thumb for contacting and operating the devices.

The portable wearable input apparatus disclosed herein comprises a wearable unit, multiple keystroke registering units, and a mounting unit. The wearable unit is configured to conform to a body part of a wearer, for example, a wearer's hand. The wearable unit comprises a chamber for accommodating the wearer's body part. In an embodiment, the wearable unit is shaped as a mitten, free from individual finger sheaths for increasing the surface area for mounting the keystroke registering units. The wearable unit shaped as the mitten encloses at least four fingers of the wearer. In another embodiment, the wearable unit comprises an opening for inserting at least four fingers of the wearer and allowing free movement of the four fingers of the wearer for activating the keystroke registering units. In another embodiment, the wearable unit is a finger band wearable around the fingers of the wearer. The keystroke registering units are mounted on the finger band. A thumb opening is disposed alongside the chamber of the wearable unit for passing the wearer's thumb through the thumb opening. The thumb opening is positioned on either side of the chamber to enable the wearer to use the wearable unit on either hand. The wearable unit is free of a thumb sheath for enabling flexible movement of the wearer's thumb through the thumb opening for activating the keystroke registering units.

The keystroke registering units are detachably disposed on the chamber of the wearable unit for enabling the wearer to register keystrokes. The keystroke registering units are, for example, switches, sensors, etc. for detecting keystrokes registered by the wearer. The wearer registers the keystrokes by activating the keystroke registering units using the wearer's thumb. The mounting unit is in electric communication with the keystroke registering units. The mounting unit mechanically supports the keystroke registering units and transmits the registered keystrokes to one or more devices, for example, a computing device such as a computer. The mounting unit and the keystroke registering units are detachably connected to each other and to the wearable unit. The portable wearable input apparatus disclosed herein further comprises multiple removable electrical connectors in electric communication with the mounting unit for transmitting the registered keystrokes from the mounting unit to the devices by, for example, wired communication, wireless communication, or a combination thereof. The portable wearable input apparatus thereby furnishes the transmitted keystrokes as input to the devices.

In an embodiment, the wearable unit of the portable wearable input apparatus comprises a mounting section disposed on multiple locations on the wearable unit for mounting one or more devices, for example, an optical mouse, a joystick, etc. A controller, for example, a game controller, may be created on the portable wearable input apparatus by selectively connecting the keystroke registering units and one or more devices on the wearable unit.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a rear perspective view of an embodiment of a portable wearable input apparatus for furnishing input to one or more devices.

FIG. 2 exemplarily illustrates a front perspective view of the portable wearable input apparatus.

FIG. 3 exemplarily illustrates a front perspective view of the portable wearable input apparatus showing keystroke registering units in electric communication with a mounting unit electrically connected to removable electrical connectors.

FIG. 4 exemplarily illustrates connection of the keystroke registering units on a mounting unit to a universal serial bus switch interface via the electrical connectors.

FIG. 5 exemplarily illustrates an external view and an internal view of the electrical connectors.

FIG. 6 exemplarily illustrates wireless transmission of registered keystrokes from the keystroke registering units of the portable wearable input apparatus to the universal serial bus switch interface and a computing device.

FIG. 7 exemplarily illustrates a front perspective view of another embodiment of the portable wearable input apparatus wearable on the wearer's left hand.

FIG. 8 exemplarily illustrates a front perspective view of the portable wearable input apparatus wearable on the wearer's right hand.

FIG. 9 exemplarily illustrates a rear perspective view of the portable wearable input apparatus wearable on the wearer's right hand.

FIG. 10 exemplarily illustrates a rear perspective view of the portable wearable input apparatus wearable on the wearer's left hand.

FIG. 11 exemplarily illustrates another embodiment of the portable wearable input apparatus comprising a finger band.

FIG. 12 exemplarily illustrates the portable wearable input apparatus comprising the finger band with keystroke registering units, worn around the fingers of the wearer's left hand.

FIG. 13 illustrates a method of furnishing input to one or more devices.

### DETAILED DESCRIPTION OF THE INVENTION

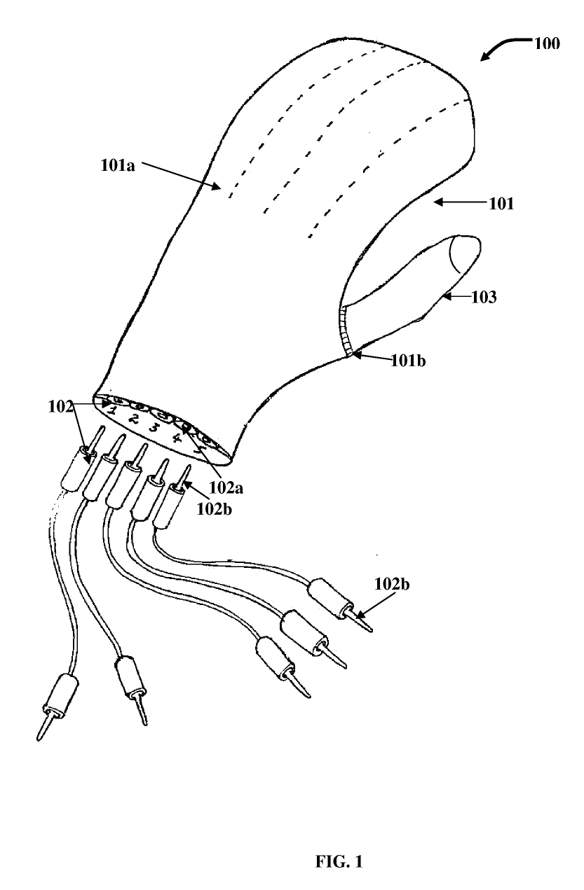

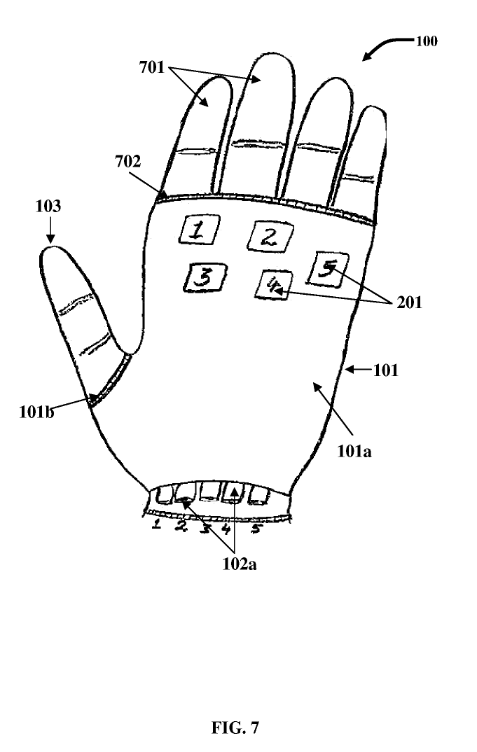

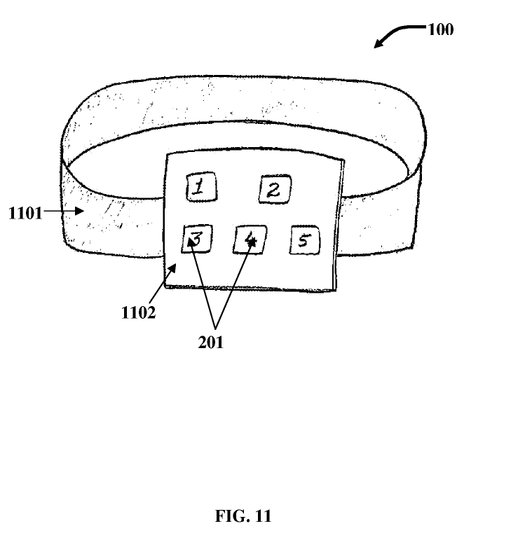

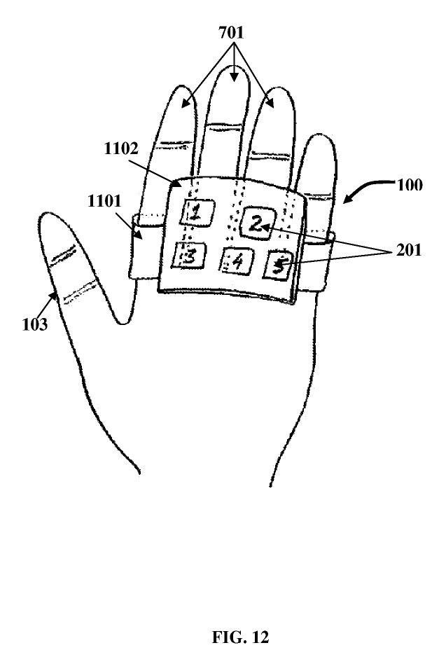

FIG. 1 exemplarily illustrates a rear perspective view of an embodiment of a portable wearable input apparatus 100 for furnishing input to one or more devices. The portable wearable input apparatus 100 disclosed herein is, for example, used in applications pertaining to assistive technologies. The portable wearable input apparatus 100 disclosed herein is used by persons with disabilities, for example, cerebral palsy or other motor disabilities that make it difficult for persons with such disabilities to use conventional input devices, for example, keyboards or computer mice. The portable wearable input apparatus 100 comprises a wearable unit 101 configured to conform to a body part of a wearer, for example, the wearer's hand or fingers. In an embodiment as exemplarily illustrated in FIGS. 1-3 and FIG. 6, the wearable unit 101 is shaped as a mitten free from individual and separate finger sheaths for increasing the surface area for mounting multiple keystroke registering units 201. In this embodiment, the wearable unit 101 shaped as a mitten encloses at least four fingers of the wearer, excluding the thumb 103. In another embodiment as exemplarily illustrated in FIGS. 7-10, the wearable unit 101 comprises an opening 702 for inserting at least four fingers 701 of the wearer and allowing free movement of the fingers 701 for activating the keystroke registering units 201. For purposes of illustration, the detailed description refers to a mitten, however the scope of the portable wearable input apparatus 100 is not limited to a mitten, but may be extended to include any wearable item, for example, a finger band 1101 as exemplarily illustrated in FIGS. 11-12, etc., that may be worn on the hands, fingers, thumbs, toes, feet, head, elbows, or any other suitable part of the wearer's body.

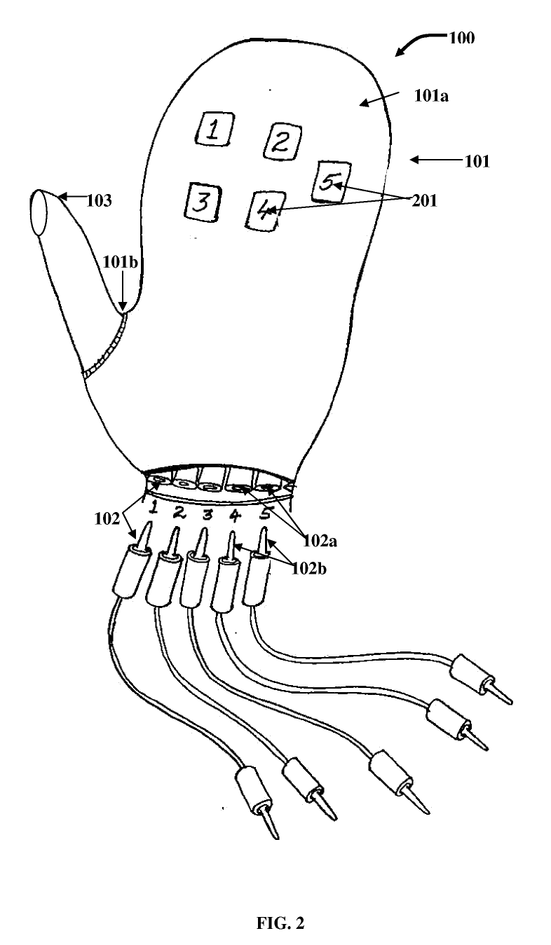

The wearable unit 101 exemplarily illustrated in FIGS. 1-3 and FIG. 6 comprises a chamber 101a for accommodating the wearer's body part, for example, the wearer's hand. For purposes of illustration, the body part herein is a hand. The portable wearable input apparatus 100 disclosed herein further comprises a thumb opening 101b disposed alongside the chamber 101a of the wearable unit 101 for passing the wearer's thumb 103 through the thumb opening 101b. The thumb opening 101b may be positioned on either side of the chamber 101a to enable the wearer to use the wearable unit 101 on either of the wearer's hands. The wearable unit 101 is also manufactured for ergonomic use by a right handed person or by a left handed person. The wearable unit 101 is worn by the wearer like an article of clothing. The wearable unit 101 provides a single chamber 101a for accommodating the fingers and upper portion of the palm of the wearer's hand. The single chamber 101a enables positioning of the keystroke registering units 201, as exemplarily illustrated in FIG. 2, throughout the outer surface of the wearable unit 101, including the area corresponding to the space between fingers of the wearer's hand. The wearable unit 101 is made of a wearable material, for example, cotton, wool, nylon, leather, elastic, rubber, etc.

The thumb opening 101b allows the wearer's thumb 103 to pass through the thumb opening 101b. The wearable unit 101 is free of a thumb sheath for enabling flexible movement of the wearer's thumb 103 through the thumb opening 101b for activating the keystroke registering units 201. The thumb 103 outside the wearable unit 101 is uncovered or unobstructed by any fabric or wearable material. The uncovered thumb 103 may be used more efficiently and accurately by the wearer since the thumb 103 is not obstructed.

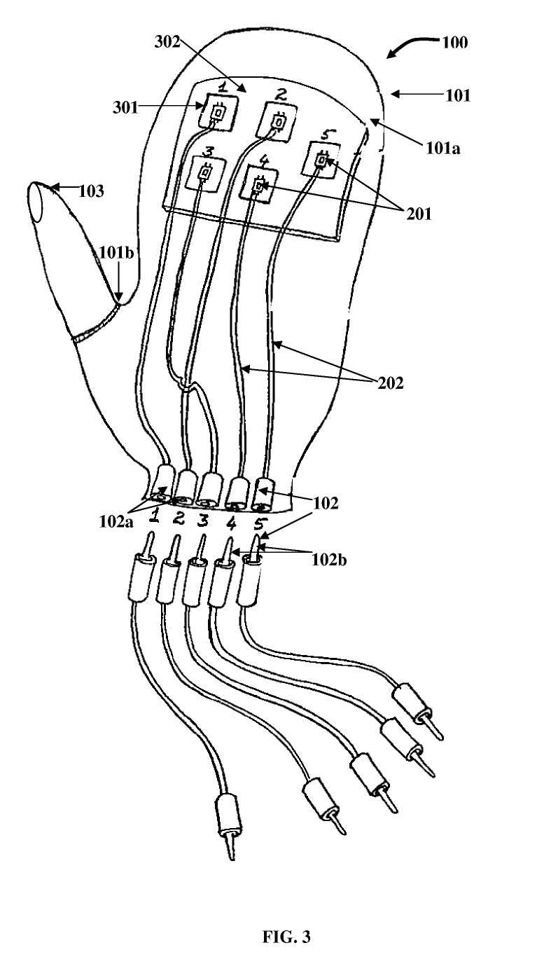

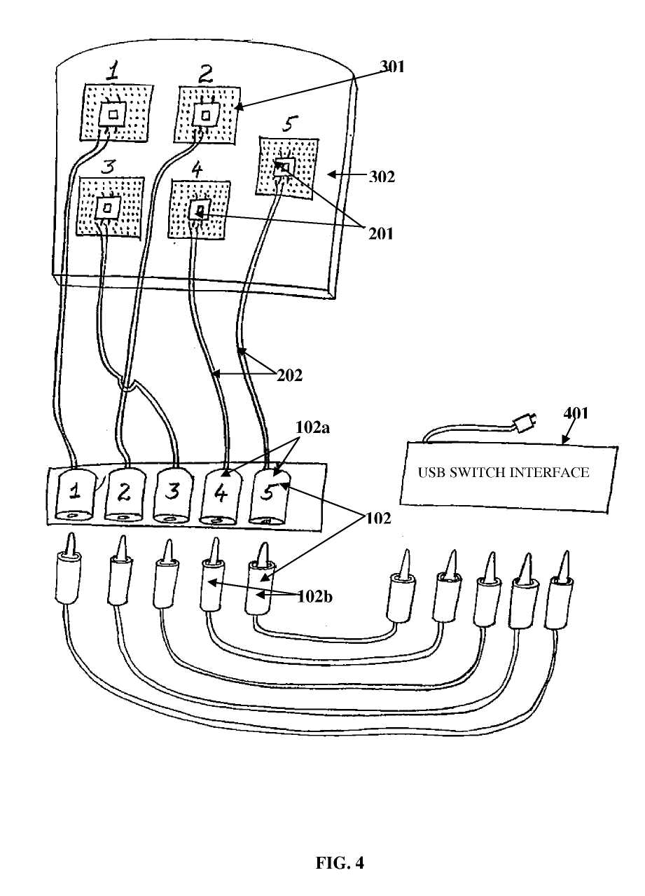

The portable wearable input apparatus 100 further comprises removable electrical connectors 102 in electric communication with a mounting unit 301 that mechanically supports the keystroke registering units 201, for transmitting the registered keystrokes from the mounting unit 301 to one or more devices, for example, computers, laptops, mobile devices, personal digital assistants (PDAs), gaming devices, and other interactive educational and entertainment devices, etc. as disclosed in the detailed description of FIGS. 3-4.

FIG. 2 exemplarily illustrates a front perspective view of the portable wearable input apparatus 100. As illustrated in FIG. 2, the portable wearable input apparatus 100 disclosed herein further comprises multiple keystroke registering units 201. The keystroke registering units 201 are detachably disposed on the chamber 101a of the wearable unit 101. The keystroke registering units 201 may be detached from the wearable unit 101. The keystroke registering units 201 enable the wearer to register keystrokes. The wearer registers the keystrokes by activating the keystroke registering units 201 using, for example, the wearer's thumb 103. The keystroke registering units 201 may be frontally and/or posteriorly disposed on the chamber 101a of the wearable unit 101. The keystroke registering units 201 are provided on the wearable unit 101 at locations easily accessible to the wearer using the thumb 103. The locations may be easily accessible even if the wearer has a disability that limits dexterity of the thumb 103. The keystroke registering units 201 may be provided at different locations on the wearable unit 101 for different wearers, depending upon the condition of the wearer. For example, if a wearer has a motor disability that does not affect the range of motion of the thumb 103 but limits accuracy of the motion, the keystroke registering units 201 may be provided far apart from each other on the chamber 101a. However, if the range of motion of the thumb 103 is limited but the wearer is able to control the thumb 103 with a considerable degree of accuracy, the keystroke registering units 201 may be provided close to each other on the chamber 101a. Hence, the portable wearable input apparatus 100 is customizable according to the needs of the wearer.

The keystroke registering units 201 may be used by the wearer by simply moving the thumb 103 around to access the keystroke registering units 201. The wearer does not need to move any limbs or other parts of the body to use the keystroke registering units 201. The wearer also does not need to bend fingers to access the keystroke registering units 201, thereby allowing ease of operation of the keystroke registering units 201 by the wearer. As an example, 5 keystroke registering units 201 may be provided on a single wearable unit 101 as exemplarily illustrated in FIG. 2. If the wearer wears one wearable unit 101 on each hand, the wearer can access 10 keystroke registering units 201. Each of the keystroke registering units 201 may correspond to a key on a computer keyboard, for example, keys, such as enter, space, up arrow, down arrow, delete, backspace, or numbers 0 to 5, etc. The keystroke registering units 201 are mounted on a mounting unit 301 and are electrically connected to electrical connectors 102 by, for example, wires 202.

In an embodiment, the keystroke registering units 201 are, for example, switches. The keystrokes are registered on key press of one or more switches. The switches are, for example, tact switches, membrane switches, snap action switches, optical switches, ultra miniature toggle switches, foot actuated air switches, photoelectric switches, etc. In another embodiment, the keystroke registering units 201 are, for example, sensors (not shown) for sensing the motion of the thumb 103 without the wearer having to press any switches. The sensors are, for example, pressure sensors, magnetic sensors, light sensors, infrared (IR) sensors, motion sensors, gyro sensors, temperature sensors, bending sensors, touch sensors, etc. The sensors may be helpful to patients who are unable to press down on the switches to use them. In such a case, the tact switches may be replaced by sensors. Alternatively, the sensors may also be provided in addition to the tact switches. The position, sensitivity, and functions of the sensors are configured differently for each wearer depending on the condition of the wearer.

FIG. 3 exemplarily illustrates a front perspective view of the portable wearable input apparatus 100 showing keystroke registering units 201 in electric communication with a mounting unit 301 electrically connected to removable electrical connectors 102. As illustrated in FIG. 3, the portable wearable input apparatus 100 disclosed herein further comprises a mounting unit 301 in electric communication with the keystroke registering units 201. The keystroke registering units 201 are detachably connected to the mounting unit 301. The mounting unit 301 and the keystroke registering units 201 may be detached from each other and the wearable unit 101.

The wearable unit 101 may comprise a flexible padded area 302 on the inner surface of the chamber 101a corresponding to the area between the fingers and the palm of the hand for providing a stable surface or platform to mount the switches. Therefore, when the switches are pressed, the switches do not tend to slip away from their initial position. The flexible padded area 302 is useful to cerebral palsy patients as finger movement is highly erratic and absence of the flexible padded area 302 would cause the switches to slip from their initial positions on the wearable unit 101. The flexible padded area 302 enables positioning of switches on areas of the wearable unit 101 between or around the fingers and the palm of the hand for accommodation of additional switches at positions convenient for the wearer.

Each of the keystroke registering units 201 may be electrically connected to a mounting unit 301. The mounting unit 301 mechanically supports the keystroke registering units 201. The mounting unit 301 is, for example, a printed circuit board (PCB). The PCB may be mounted on the flexible padded area 302 for providing flexibility of positioning and mounting of the keystroke registering units 201 anywhere around the fingers. The flexible padded area 302 also provides a firm base, so that the keystroke registering units 201 do not slip from their original, intended place. The mounting unit 301 is electrically connected to the keystroke registering units 201 within the chamber 101a of the wearable unit 101 for transmitting the registered keystrokes to one or more devices. The registered keystrokes are transmitted to one or more devices by, for example, wired communication, wireless communication, or a combination thereof.

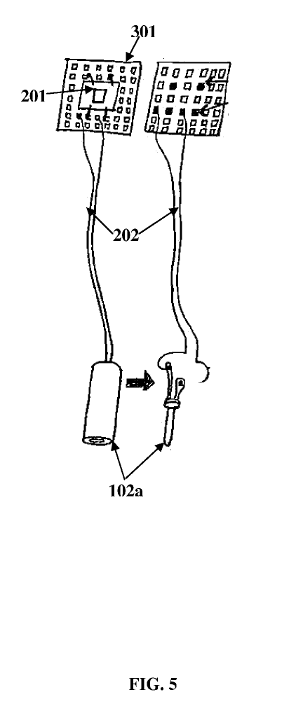

FIGS. 4-5 exemplarily illustrate removable electrical connectors 102 used for transmitting the registered keystrokes to one or more devices. As disclosed in the detailed description of FIG. 1, the removable electrical connectors 102 are in electric communication with the mounting unit 301. The registered keystrokes are transmitted to one or more devices electrically via the electrical connectors 102. The electrical connectors 102 are connectible to the mounting unit 301 by, for example, wires 202. The electrical connectors 102 transmit the registered keystrokes from the mounting unit 301 to the devices. The devices are, for example, computers, laptops, mobile devices, personal digital assistants (PDAs), gaming devices, and other interactive educational and entertainment devices, etc.

The electrical connectors 102 are, for example, audio connectors 102. The audio connectors 102 may be provided on the wearable unit 101 at the wrist level of the wearer. The audio connectors 102 comprise, for example, male connectors 102b for plugging into the female connectors 102a for transmitting the registered keystrokes. An external view and an internal view of the electrical connectors 102 are exemplarily illustrated in FIG. 5.

The electrical connectors 102 may be used with a universal serial bus (USB) switch interface 401 which plugs into a USB port on any of the devices and converts the registered keystrokes in the electrical connectors 102 to a USB compatible format. The connection of the keystroke registering units 201 on the mounting unit 301 to the USB switch interface 401 via the electrical connectors 102 is exemplarily illustrated in FIG. 4. In an embodiment, the electrical connectors 102 may also be connected to the wearable unit 101 via snap buttons (not shown) typically used in items of clothing. The snap buttons may be used in place of the female connectors 102a and the male connectors 102b to provide cost effectiveness and unobtrusiveness.

The electrical connectors 102 are also removable from the wearable unit 101 when not in use. The electrical connectors 102 can be removed from the wearable unit 101 so that the electrical connectors 102 do not obstruct the wearer's hand during insertion into the wearable unit 101.

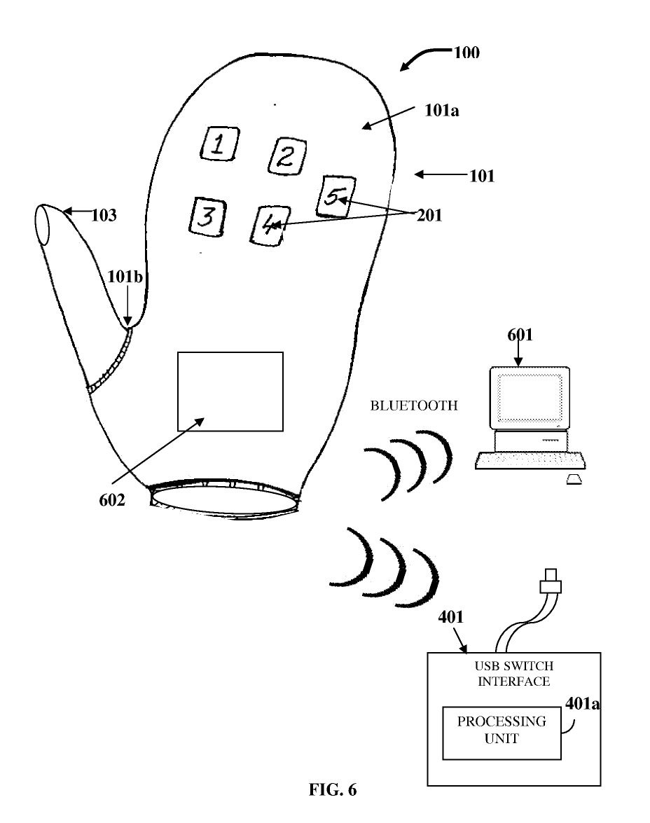

FIG. 6 exemplarily illustrates wireless transmission of registered keystrokes from the keystroke registering units 201 of the portable wearable input apparatus 100 to the USB switch interface 401 and a computing device 601. In another embodiment, the registered keystrokes are transmitted wirelessly, for example, via a Bluetooth® wireless protocol. A Bluetooth transmitter (not shown) may be provided on the wearable unit 101 for wirelessly transmitting the registered keystrokes to one or more devices comprising a Bluetooth® receiver (not shown). The Bluetooth® receiver may, for example, be connected to the USB switch interface 401 of the devices or to a computing device 601. Wireless transmission of the registered keystrokes from the mounting unit 301 to the USB switch interface 401 and a computing device 601, for example, a computer is exemplarily illustrated in FIG. 6. Although the wireless transmission of the registered keystrokes is disclosed herein with reference to a Bluetooth wireless protocol, the scope of the method disclosed herein is not limited to a Bluetooth wireless protocol but may be extended to include infrared and other wireless communication protocols. Therefore, the portable wearable input apparatus 100 may wirelessly communicate via the USB switch interface 401, or directly to a computer 601, for example, through Bluetooth, infrared, or other wireless communication protocols.

The USB interface 401 comprises a processing unit 401a for processing the transmitted keystrokes. The processing unit 401a comprises multiple microchips. The microchips may be specialized keyboard microcontrollers, for example, Intel® 83C51KB, or general purpose microcontrollers, for example, Intel® 8051, programmed for use with a keyboard interface. The registered keystrokes are mapped to a keypad matrix interfaced with the processing unit 401a. The keypad matrix is, for example, an 8×8 matrix or a 16×16 matrix. Each keystroke is mapped to a unique combination of row number and column number in the keypad matrix. The processing unit 401a reads the unique combination of each keystroke and generates key codes corresponding to the unique combinations of the keystrokes.

The portable wearable input apparatus 100 may further comprise a touchpad (not shown) mounted on the wearable unit 101 for enabling the wearer to control a pointer on any of the devices. For example, the wearer may use the touchpad to control a mouse pointer on a computer 601. The portable wearable input apparatus 100 further comprises, for example, switches which may operate like a mouse or a joystick for enabling the wearer to control the pointer or provide directional input to the devices. The wearable unit 101 comprises a mounting section 602 disposed on different locations on the wearable unit 101 for mounting and connecting one or more devices, for example, a computer mouse, a joystick, etc. The keystroke registering units 201, the touchpad, and the joystick may further be used in any combination to create, for example, a game controller on the wearable unit 101. Creating a game controller on the wearable unit 101 enables persons suffering from motor disabilities to play games on computers or gaming consoles. The game controller may be created on the portable wearable input apparatus 100 by selectively connecting the keystroke registering units 201 and different devices on the wearable unit 101. Furthermore, wireless remote control devices enabling the wearer to control different devices, for example, television (TV) sets, radios, digital versatile disc (DVD) players, etc. may also be provided on the portable wearable input apparatus 100. Hence, the portable wearable input apparatus 100 provides the wearer with motor disabilities access to a many different types of devices, including, for example, computers, PDAs, gaming consoles, TV sets, radios, DVD players, etc.

In addition to use by persons of motor disabilities, the portable wearable input apparatus 100 is used, for example, to operate toys, electronic devices, gaming devices, remote controlled devices, health and fitness equipment, educational equipment for normal as well as disabled or differently abled persons, etc. The portable wearable input apparatus 100 is also used in physical based robotics applications and any other applications or apparatuses that require switching. The portable wearable input apparatus 100 further provides tactile feedback to the wearer upon activation of the keystroke registering units 201. The tactile feedback provided may, for example, be in the form of a vibration.

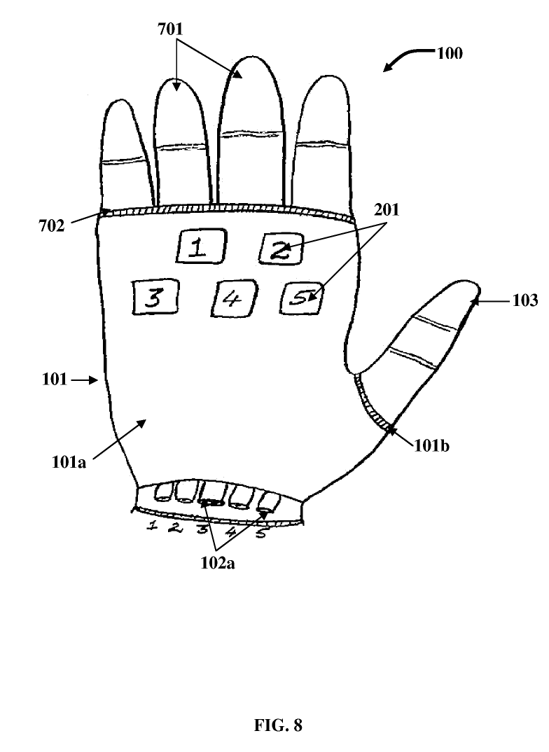

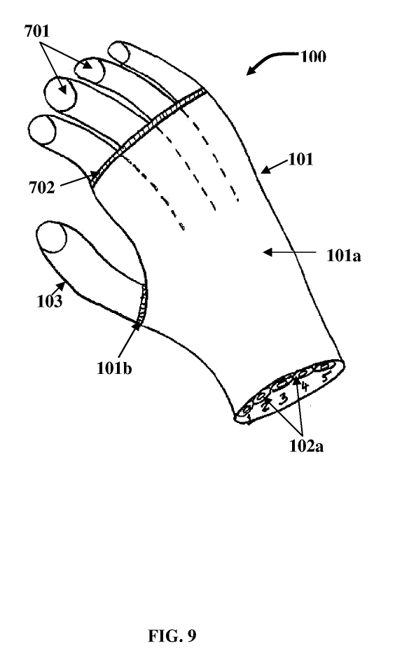

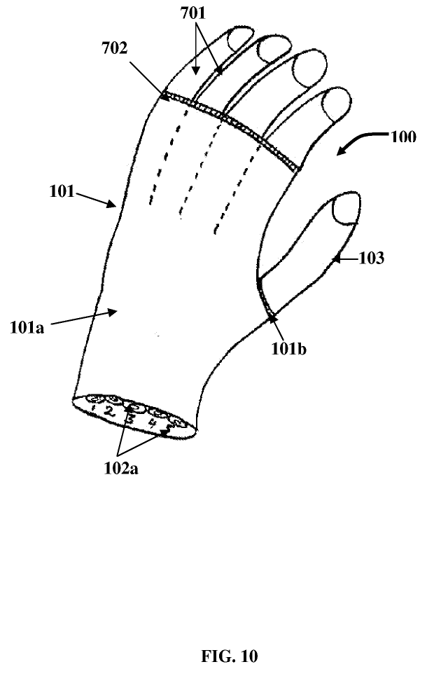

FIGS. 7-10 exemplarily illustrate another embodiment of the portable wearable input apparatus 100. The portable wearable input apparatus 100 comprises a wearable unit 101 with the thumb opening 101b and the keystroke registering units 201. The thumb opening 101b may be on either side of the chamber 101a to enable the wearer to use the same wearable unit 101 on either of the wearer's hands. FIG. 7 exemplarily illustrates a front perspective view of the portable wearable input apparatus 100 wearable on the wearer's left hand. In this embodiment, the chamber 101a of the wearable unit 101 comprises an opening 702 for inserting the other fingers 701 of the wearer's hand as illustrated in FIGS. 7-10. The opening 702 leads the fingers 701 outside the wearable unit 101. The fingers 701 outside the wearable unit 101 are uncovered and unobstructed by any fabrics or wearable materials. The fingers 701 may be used more efficiently and precisely by the wearer since the fingers 701 may be used without any obstruction. FIG. 8 exemplarily illustrates a front perspective view of the portable wearable input apparatus 100 wearable on the wearer's right hand. FIG. 9 exemplarily illustrates a rear perspective view of the portable wearable input apparatus 100 wearable on the wearer's right hand. FIG. 10 exemplarily illustrates the rear perspective view of the portable wearable input apparatus 100 wearable on the wearer's left hand.

FIGS. 11-12 exemplarily illustrate another embodiment of the portable wearable input apparatus 100. In this embodiment, the portable wearable input apparatus 100 is a finger band 1101 comprising keystroke registering units 201, worn around the fingers 701 of the wearer's hand. The finger band 1101 may be tied around the fingers 701 of the wearer's left hand as exemplarily illustrated in FIG. 12. A support surface 1102 is attached to the finger band 1101 as illustrated in FIGS. 11-12. The keystroke registering units 201 are mounted on the support surface 1102. The keystroke registering units 201 may be detachably disposed on the support surface 1102 and may be activated using the thumb 103 or any of the fingers 701. The portable wearable input apparatus 100 enables movement of the thumb 103 and the other fingers 701 for registering the keystrokes.

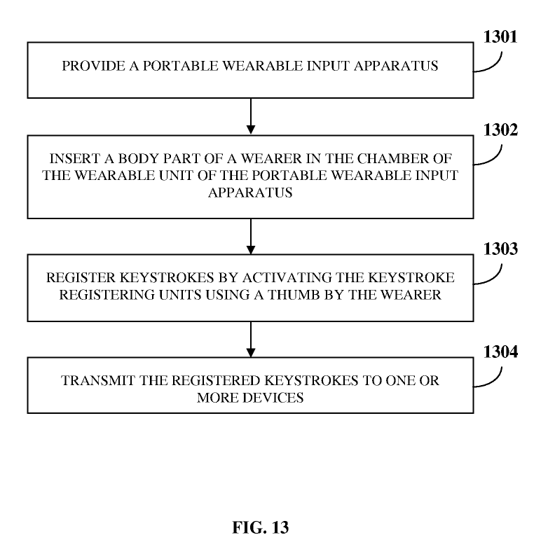

FIG. 13 illustrates a method of furnishing input to one or more devices. A portable wearable input apparatus 100 comprising a wearable unit 101, keystroke registering units 201, a mounting unit 301, and removable electric connectors 102 as disclosed in the detailed description of FIGS. 1-12 is provided 1301. A wearer inserts 1302 a body part, for example, the wearer's hand, in the chamber 101a of the wearable unit 101. The wearer's hand is positioned in a utilization position. The positioning comprises inserting the hand in the chamber 101a and passing the thumb 103 through the thumb opening 101b. The wearer registers 1303 keystrokes by activating the keystroke registering units 201 using the wearer's thumb 103. The registered keystrokes are transmitted 1304 to one or more devices by, for example, wired communication, wireless communication, and a combination thereof. The registered keystrokes are transmitted wirelessly to one or more devices, for example, via a Bluetooth wireless protocol. The registered keystrokes may also be transmitted to one or more devices using, for example, the electrical connectors 102. The transmitted keystrokes are thereby furnished as input to the devices using the portable wearable input apparatus 100. The transmitted keystrokes are processed by a processing unit 401a of one or more devices.

The portable wearable input apparatus 100 enables a wearer suffering from motor disabilities, for example, cerebral palsy, to register an average of about 30 to 50 keystrokes per minute. However, the number of keystrokes registered by each wearer may vary significantly from the average depending on the condition the wearer suffers from and the natural disposition of the wearer. The average of 30 to 50 keystrokes per minute may be regarded as a considerably high speed of operation of the keystroke registering units 201 by the wearer with motor disabilities.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A portable wearable input apparatus for furnishing input to one or more devices, comprising:
a wearable unit configured to conform to a body part of a wearer, wherein said wearable unit comprises a chamber for accommodating said body part of said wearer;
a plurality of keystroke registering units detachably disposed on said chamber of said wearable unit for enabling said wearer to register keystrokes, wherein said wearer registers said keystrokes by activating said keystroke registering units; and
a mounting unit in electric communication with said keystroke registering units, wherein said mounting unit mechanically supports said keystroke registering units and transmits said registered keystrokes to said one or more devices;
whereby said portable wearable input apparatus furnishes said transmitted keystrokes as said input to said one or more devices.

2. The portable wearable input apparatus of claim 1, further comprising a plurality of removable electrical connectors in electric communication with said mounting unit for transmitting said registered keystrokes from said mounting unit to said one or more devices.

3. The portable wearable input apparatus of claim 1, wherein said registered keystrokes are transmitted to said one or more devices by one of wired communication, wireless communication, and a combination thereof.

4. The portable wearable input apparatus of claim 1, wherein said keystroke registering units are one or more of switches and sensors for detecting said keystrokes registered by said wearer.

5. The portable wearable input apparatus of claim 1, wherein said body part is one of a hand and fingers of said wearer.

6. The portable wearable input apparatus of claim 1, wherein said wearable unit is shaped as a mitten free from individual finger sheaths for increasing surface area for mounting said keystroke registering units.

7. The portable wearable input apparatus of claim 6, wherein said wearable unit shaped as said mitten encloses at least four fingers of said wearer.

8. The portable wearable input apparatus of claim 1, wherein said wearable unit comprises an opening for inserting at least four fingers of said wearer and allowing free movement of said at least four fingers of said wearer for activating said keystroke registering units.

9. The portable wearable input apparatus of claim 1, wherein said wearable unit is a finger band wearable around fingers of said wearer, wherein said keystroke registering units are mounted on said finger band.

10. The portable wearable input apparatus of claim 1, further comprising a thumb opening disposed alongside said chamber of said wearable unit for passing a thumb of said wearer, wherein said thumb opening is positioned on either side of said chamber to enable said wearer to use said wearable unit on either hand of said wearer.

11. The portable wearable input apparatus of claim 10, wherein said wearable unit is free of a thumb sheath for enabling flexible movement of said thumb of said wearer through said thumb opening for activating said keystroke registering units.

12. The portable wearable input apparatus of claim 1, wherein said wearer activates said keystroke registering units using a thumb.

13. The portable wearable input apparatus of claim 1, wherein said wearable unit comprises a mounting section disposed on a plurality of locations on said wearable unit for mounting said one or more devices.

14. The portable wearable input apparatus of claim 1, wherein said mounting unit and said keystroke registering units are detachably connected to each other and to said wearable unit.

15. A method of furnishing input to one or more devices, comprising:
providing a portable wearable input apparatus comprising:
a wearable unit configured to conform to a body part of a wearer, wherein said wearable unit comprises a chamber for accommodating said body part of said wearer, and wherein said wearable unit further comprises a thumb opening disposed alongside said chamber for passing a thumb of said wearer;
a plurality of keystroke registering units detachably disposed on said chamber of said wearable unit; and
a mounting unit in electric communication with said keystroke registering units, wherein said mounting unit mechanically supports said keystroke registering units;
inserting said body part of said wearer in said chamber of said wearable unit;
registering keystrokes by activating said keystroke registering units using said thumb by said wearer; and
transmitting said registered keystrokes to said one or more devices by one of wired communication, wireless communication, and a combination thereof;
whereby said transmitted keystrokes are furnished as said input to said one or more devices using said portable wearable input apparatus.

16. The method of claim 15, wherein said portable wearable input apparatus further comprises a plurality of removable electrical connectors in electric communication with said mounting unit for transmitting said registered keystrokes from said mounting unit to said one or more devices.

17. The method of claim 15, further comprising mounting and connecting said one or more devices on a mounting section disposed on a plurality of locations on said wearable unit.

18. The method of claim 15, further comprising creating a controller on said portable wearable input apparatus by selectively connecting said keystroke registering units and said one or more devices on said wearable unit.
